(19) United States
(12) Patent Application Publication
(10) Pub. No.: US 2026/0159080 A1
(43) Pub. Date: Jun. 11, 2026

(54) METHOD AND SYSTEM FOR CONTROLLING VEHICLE IN CASE OF REDUCTION IN RELIABILITY OF LANE INFORMATION

(71) Applicant: HL Klemove Corp., Incheon (KR)

(72) Inventor: Junhyeok KANG, Incheon (KR)

(73) Assignee: HL Klemove Corp., Incheon (KR)

(21) Appl. No.: 19/064,949

(22) Filed: Feb. 27, 2025

(30) Foreign Application Priority Data
Dec. 11, 2024 (KR) 10-2024-0183361

(51) Int. Cl. B60W 30/12; B60W 10/20; G06V 20/56

(52) U.S. Cl. CPC B60W 30/12; B60W 10/20; G06V 20/588; B60W 2420/403; B60W 2540/18; B60W 2552/30; B60W 2552/53; B60W 2556/20

(57) ABSTRACT

A method and a system for controlling a vehicle in case of reduction in reliability of lane information are provided, and the method for controlling a vehicle in case of reduction in reliability of lane information according to an embodiment of the present disclosure comprises: detecting at least one lane line located ahead in a driving lane of an ego vehicle using a sensor of the ego vehicle; determining a lane-based path represented by an n^{th} degree polynomial based on the detected lane line; calculating an amount of change in each coefficient of the n^{th} degree polynomial; calculating a path reliability of the lane-based path using the amount of change in each coefficient; determining a required steering angle rate of the ego vehicle based on the path reliability; and controlling the ego vehicle according to the required steering angle rate.

### CROSS-REFERENCE TO RELATED APPLICATION

This application claims the benefit of and priority to Korean Patent Application No. 10-2024-0183361 filed on Dec. 11, 2024, the entire disclosures of which are incorporated herein by reference.

### TECHNICAL FIELD

The present disclosure relates to a method and system for controlling a vehicle in case of reduction in reliability of lane information. More specifically, the present disclosure relates to a method and system for controlling a vehicle in case of reduction in reliability of lane information to adjust the steering angle rate of the vehicle based on the calculated path reliability when the reliability of the detected lane information is low.

### BACKGROUND

In a vehicle, a driver assistance system provides assistance to the driver while driving in the vehicle for the driver's convenience.

For example, Lane Following Assist (LFA) refers to a function that ensures the vehicle to follow the center of the lane based on the camera-recognized lane.

In the lane following assist system, the lane information recognized by the camera can be damaged for various reasons, and depending on the degree of damage to the lane information, the function may be deactivated or the lane information may be used as it is. Meanwhile, when both of left lane line information and right lane line information are damaged, it is difficult to generate a virtual lane line. Further, if the damage is not severe enough to deactivate the system, the system typically uses the detected values for control, and this control may increase the risk of accidents and cause anxiety for the driver.

Therefore, there is a need for a method and system for controlling the vehicle in case of reduction in reliability of lane information that can stably perform lane following assist system even when the lane line is damaged or incorrectly recognized.

### SUMMARY

The present disclosure is to solve the above-mentioned problems of the prior art, and the object of the present disclosure is to provide a method and system for controlling the vehicle in case of reduction in reliability of lane information that can reduce the impact of miscontrol of the vehicle in cases where the lane is incorrectly recognized, by calculating the path reliability based on the detected lane line and controlling the vehicle based on the path reliability.

Further, the object of the present disclosure is to provide a method and system for controlling the vehicle in case of reduction in reliability of lane information that can reduce the risk of accidents and promote stable driving of the vehicle even in case of unstable lane recognition, by calculating the path reliability of a lane-based path and adjusting the steering angle rate based on the path reliability.

However, the technical problem to be achieved by the embodiments of the present disclosure is not limited to the technical problems described above, and other technical problems may exist.

As a technical means for achieving the above technical problem, a method for controlling a vehicle in case of reduction in reliability of lane information according to an embodiment of the present disclosure comprises: detecting at least one lane line located ahead in a driving lane of an ego vehicle using a sensor of the ego vehicle; determining a lane-based path represented by an n^{th} degree polynomial based on the detected lane line; calculating an amount of change in each coefficient of the n^{th} degree polynomial; calculating a path reliability of the lane-based path using the amount of change in each coefficient; determining a required steering angle rate of the ego vehicle based on the path reliability; and controlling the ego vehicle according to the required steering angle rate.

Further, the calculating of the path reliability may comprise: calculating a coefficient reliability using the amount of change in each coefficient; and calculating the path reliability by adding up coefficient reliabilities for a plurality of coefficients.

Further, the calculating of the coefficient reliability may comprise: if the amount of change in each coefficient is smaller than a predetermined threshold value, setting the corresponding coefficient reliability to 1; and if the amount of change in each coefficient is greater than or equal to the threshold value, setting the corresponding coefficient reliability to a value smaller than 1.

Further, the calculating of the amount of change in each coefficient may comprise calculating the amount of change in each coefficient during a minimum time interval for system operation.

Further, the determining of the required steering angle rate may comprise: calculating a first angle rate required to reach a target point based on the lane-based path; calculating a second angle rate corresponding to a limit value based on the path reliability; and calculating the required steering angle rate by subtracting the second angle rate from the first angle rate.

Further, the determining of the lane-based path comprises representing coordinates of both lane lines on the driving lane of the ego vehicle as separate n^{th} degree polynomials.

Further, the calculating of the path reliability may comprise: determining a path reliability for a left lane line of the driving lane using amount of change in each coefficient of the n^{th} degree polynomial for coordinates of the left lane line; determining a path reliability for a right lane line of the driving lane using the amount of change in each coefficient of the n^{th} degree polynomial for coordinates of the right lane line; and determining an average value of the path reliability of the left lane line and the path reliability of the right lane line as the path reliability of the lane-based path.

Further, the determining of the lane-based path may comprise representing lane center coordinates of the driving lane of the ego vehicle as the n^{th} degree polynomial.

Further, a first-degree coefficient of the n^{th} degree polynomial may be a heading angle of the ego vehicle with respect to the lane-based path.

Further, a second-degree coefficient of the n^{th} degree polynomial may be a curvature of the lane-based path.

A system for controlling a vehicle in case of reduction in reliability of lane information according to the embodiments of the present disclosure comprises: a sensor configured to detect at least one lane line located ahead in a driving lane of an ego vehicle; and a controller comprising at least one processor configured to perform control of the ego vehicle based on detection information from the sensor, wherein the controller is configured to determine a lane-based path represented by an n^{th} degree polynomial based on the detected lane line, calculate an amount of change in each coefficient of the n^{th} degree polynomial, calculate a path reliability of the lane-based path using the amount of change in each coefficient, determine a required steering angle rate of the ego vehicle based on the path reliability, and control the ego vehicle according to the required steering angle rate.

The system may further comprise: a driving apparatus configured to control a longitudinal driving of the ego vehicle; and a steering apparatus configured to control a lateral driving of the ego vehicle, wherein, the controller may be configured to control the steering apparatus so that the lateral driving of the ego vehicle is controlled according to the required steering angle rate.

Further, the sensor may comprise a front camera.

Further, the controller may be configured to calculate a plurality of coefficient reliabilities using the amount of change in each coefficient and calculate the path reliability by adding up the plurality of coefficient reliabilities.

Further, if the amount of change in each coefficient is smaller than a predetermined threshold value, the corresponding coefficient reliability may be set to 1 and, if the amount of change in each coefficient is greater than or equal to the threshold value, the corresponding coefficient reliability may be set to a value smaller than 1.

Further, the controller may be configured to calculate the amount of change in each coefficient during a minimum time interval for system operation.

Further, the controller may be configured to calculate a first angle rate to reach a target point based on the lane-based path, calculate a second angle rate corresponding to a limit value based on the path reliability, and calculate the required steering angle rate by subtracting the second angle rate from the first angle rate.

Further, a first-degree coefficient of the n^{th} degree polynomial may be a heading angle of the ego vehicle with respect to the lane-based path.

Further, a second-degree coefficient of the n^{th} degree polynomial may be a curvature of the lane-based path.

In a non-transitory computer-readable recording medium that records a program for executing a method for controlling a vehicle in case of reduction in reliability of lane information on a computer according to an embodiment of the present disclosure, the method comprises: detecting at least one lane line located ahead in a driving lane of an ego vehicle using a sensor of the ego vehicle; determining a lane-based path represented by an n^{th} degree polynomial based on the detected lane line; calculating an amount of change in each coefficient of the n^{th} degree polynomial; calculating a path reliability of the lane-based path using the amount of change in each coefficient; determining a required steering angle rate of the ego vehicle based on the path reliability; and controlling the ego vehicle according to the required steering angle rate.

The above-described means for solving the problem is only exemplary and should not be construed as limiting the present disclosure. In addition to the exemplary embodiments described above, additional embodiments may exist in the drawings and the following detailed description.

According to the above-described problem-solving means of the present disclosure, it is possible to provide a method and system for controlling the vehicle in case of reduction in reliability of lane information that can reduce the impact of vehicle miscontrol and decrease the risk of accidents even when the lane line is damaged or incorrectly recognized by calculating the path reliability for the lane-based path and adjusting the steering angle rate of the ego vehicle based on the path reliability.

However, the effects obtainable from the present disclosure are not limited to the effects described above, and other effects may exist.

### BRIEF DESCRIPTION OF THE DRAWINGS

FIG. 1 is a control flowchart showing a method for controlling the vehicle in case of reduction in reliability of lane information according to an embodiment of the present disclosure.

FIG. 2 is a control flowchart specifically showing the step of calculating the path reliability of the lane-based path in the method for controlling the vehicle in case of reduction in reliability of lane information according to the embodiment of the present disclosure.

FIG. 3 is a control flowchart specifically showing the step of calculating the required steering angle rate of the ego vehicle based on the path reliability in the method for controlling the vehicle in case of reduction in reliability of lane information according to the embodiment of the present disclosure.

FIG. 4 is a graph illustrating the path reliability and the angle request of the vehicle in the case where the lane lines are incorrectly recognized in the method for controlling the vehicle in case of reduction in reliability of lane information according to the embodiment of the present disclosure.

FIG. 5 is a control configuration diagram schematically showing the configuration of a system for controlling the vehicle in case of reduction in reliability of lane information according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for controlling the vehicle in case of reduction in reliability of lane information, which calculates the path reliability based on the detected lane line, determines the steering angle rate according to the path reliability, and controls the vehicle accordingly.

In the method for controlling the vehicle in case of reduction in reliability of lane information according to an embodiment of the present disclosure, the vehicle may include the driver assistance system, which may, for example, include the lane following assist system. Specifically, the lane following assist system may be a system that assists the vehicle to maintain its position in the center of the driving lane by recognizing the lane lines of the driving lane where the vehicle is traveling on.

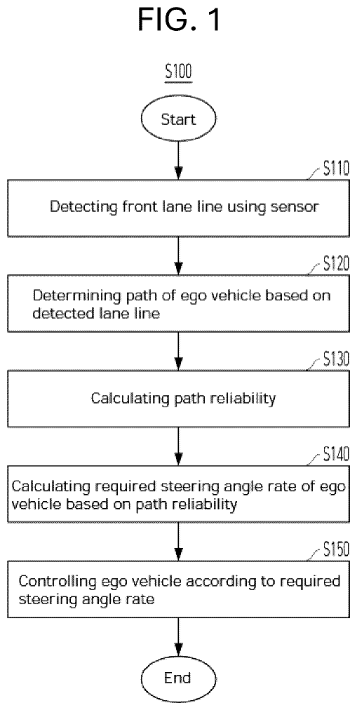

FIG. 1 is a control flowchart showing a method for controlling the vehicle in case of reduction in reliability of lane information according to an embodiment of the present disclosure.

Referring to FIG. 1 of the present disclosure, the method for controlling the vehicle in case of reduction in reliability of lane information S100 according to an embodiment of the present disclosure may include a step of detecting lane lines ahead using a sensor S110.

For example, the sensor mounted at the ego vehicle may detect both lane lines in the lane ahead where the ego vehicle is driving. Here, the sensor may comprise a front camera but is not limited to this and may also comprise other sensors capable of detecting lane lines, such as LiDAR. On the other hand, the lane information detected by the sensor may be incorrectly recognized due to situations such as lane line damage or being blocked by a vehicle ahead (reduction in reliability).

Subsequently, a step of determining the path of the ego vehicle based on the detected lane lines S120 may be performed.

Here, the lane-based path based on the detected lane lines may be represented by at least one n^{th} degree polynomial. For example, the coordinates of both (left and right) lane lines in the lane where the ego vehicle is traveling on may be represented by separate n^{th} degree polynomials. In this case, the lane-based path may be expressed by two n^{th} degree polynomials.

Alternatively, the lane-based path may be the lane center coordinates of the lane where the ego vehicle is traveling on represented by an n^{th} degree polynomial. In this case, the lane-based path may be expressed by a single n^{th} degree polynomial.

Here, the first degree coefficient of the n^{th} degree polynomial may be the heading angle of the ego vehicle with respect to the lane-based path, and the second degree coefficient of the n^{th} degree polynomial may be the curvature of the lane-based path.

Subsequently, a step of calculating the path reliability of the lane-based path S130 may be performed.

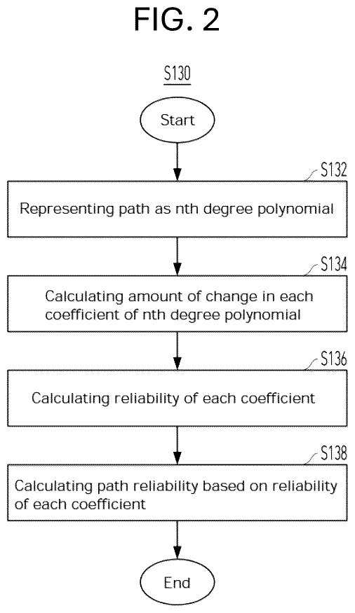

The step of calculating the path reliability S130 may comprise calculating the amount of change in each coefficient of the n^{th} degree polynomial, determining the coefficient reliability based on the amount of change in each coefficient, and calculating the path reliability by adding up the coefficient reliabilities a plurality of coefficients. The step of calculating the path reliability S130 will be explained in more detail in FIG. 2 below.

Subsequently, a step of calculating the required steering angle rate of the ego vehicle based on the path reliability of the lane-based path S140 may be performed.

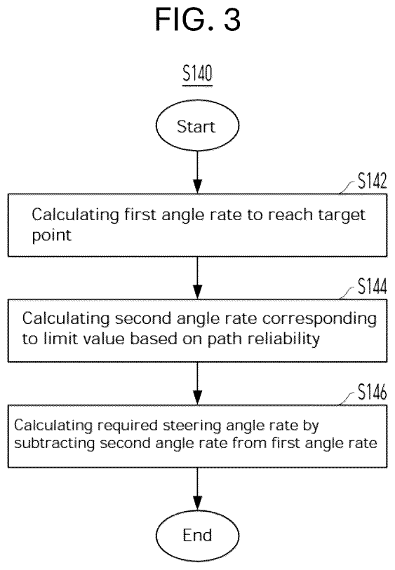

The step of calculating the required steering angle rate S140 may comprise calculating a first angle rate to reach a target point based on the lane-based path, calculating a second angle rate corresponding to a limit value according to the path reliability, and calculating a required steering angle rate by subtracting the second angle rate from the first angle rate. The step of calculating the required steering angle rate S140 will be explained in more detail in FIG. 3 below.

Subsequently, a step of controlling the ego vehicle based on the required steering angle rate S150 may be performed.

Here, the driving of the ego vehicle may be controlled by controlling the steering apparatus of the vehicle based on the required steering angle rate. Additionally, while controlling the ego vehicle according to the determined required steering angle rate, a visual or auditory warning about the reduction of the reliability of the lane information may be provided to the driver of the ego vehicle.

According to the method for controlling the vehicle in case of reduction in reliability of lane information according to an embodiment of the present disclosure, by calculating the path reliability of the lane-based path and adjusting the steering angle rate of the ego vehicle based on the path reliability, it is possible to reduce the impact of vehicle miscontrol and decrease the risk of accidents, even when the lane lines are damaged or incorrectly recognized.

FIG. 2 is a control flowchart specifically showing the step of calculating the path reliability of the lane-based path in the method for controlling the vehicle in case of reduction in reliability of lane information according to the embodiment of the present disclosure.

Referring to FIG. 2, the step of calculating the path reliability S130 may comprise a step of representing the lane-based path as an n^{th} degree polynomial S132.

Here, the lane-based path may be the coordinates of both lane lines of the lane represented by n^{th} degree polynomials. In this case, the lane-based path may be expressed by two n^{th} degree polynomials.

Alternatively, the lane-based path may be the lane center coordinates of the lane represented by an n^{th} degree polynomial. In this case, the lane-based path may be expressed by a single n^{th} degree polynomial.

Subsequently, the step of calculating the amount of change in each coefficient of the n^{th} degree polynomial S134 may be performed. For example, the amount of change in each coefficient may be calculated during the minimum time interval for system operation (between frames).

Here, the first-degree coefficient of the n^{th} degree polynomial may represent the heading angle of the ego vehicle with respect to the lane-based path, and the second-degree coefficient may represent the curvature of the lane-based path, but this is not limited to these.

Subsequently, the step of calculating the coefficient reliability for each coefficient of the n^{th} degree polynomial S136 may be performed.

Here, if the lane-based path is continuous, the amount of change in each coefficient of the n^{th} degree polynomial during the minimum time interval for system operation (between frames) cannot exceed a certain threshold value. Therefore, if the amount of change in each coefficient of the n^{th} degree polynomial exceeds a predetermined threshold value, it may be considered that the lane has been incorrectly recognized.

Therefore, in the step of calculating the coefficient reliability S136, if the amount of change in each coefficient is smaller than a predetermined threshold value, the coefficient reliability for that coefficient may be set to 1. If the amount of change in each coefficient is greater than or equal to the predetermined threshold value, the coefficient reliability for that coefficient may be a value greater than 0 and less than 1.

Here, the predetermined threshold value for the amount of change in each coefficient used in the calculation of the coefficient reliability may be set differently as needed, and it may be a value that can be adjusted based on the changing rate of each coefficient.

Subsequently, the step of calculating the path reliability based on the coefficient reliability S138 may be performed. In this case, the path reliability can be calculated by adding up the coefficient reliabilities for the plurality of coefficients.

For example, if the lane-based path is the center coordinates of the driving lane represented by an n^{th} degree polynomial, the path reliability may be calculated by adding up the coefficient reliabilities for the n coefficients of a single n^{th} degree polynomial.

On the other hand, if the lane-based paths are the coordinates of both the left and right lane lines represented by n^{th} degree polynomials, the coefficient reliability for the left lane line may be calculated by using the amount of change in each coefficient of the n^{th} degree polynomial for the left lane line's coordinates. The path reliability for the left lane line may be obtained by adding up the n coefficient reliabilities. Similarly, the coefficient reliability for the right lane line may be calculated by using the amount of change in each coefficient of the n^{th} degree polynomial for the right lane line's coordinates. The path reliability for the right lane line may be obtained by adding up the n coefficient reliabilities. Finally, the path reliability of the lane may be determined by taking the average of the path reliability for the left lane line and the path reliability for the right lane line.

Alternatively, the path reliability may be determined by selecting the smaller value between the path reliability for the left lane line and the path reliability for the right lane line. However, this is only an example, and the method of determining the path reliability can be performed in various ways based on the coefficient reliabilities.

FIG. 3 is a control flowchart specifically showing the step of calculating the required steering angle rate of the ego vehicle based on the path reliability in the method for controlling the vehicle in case of reduction in reliability of lane information according to the embodiment of the present disclosure.

Referring to FIG. 3, the step of calculating the steering angle rate of the vehicle based on the path reliability S140 may comprise calculating the first angle rate S142 to reach the target point.

For example, the first angle rate required to reach the target point based on the lane-based path may be represented by the following equation.

$${δ}_{d e s}^{′} = ( L + {K}_{u s} * {V}^{2} ) * {ρ}_{d e s}^{′} \qquad [ Equation 1 ]$$

Here, δ_{des} is the steering angle, L is the vehicle's wheelbase distance (Inter-axis distance), Kᵤₛ is the understeer gradient coefficient, V is the vehicle's longitudinal speed, and ρ_{des} is the curvature of the path. The above Equation 1 may be derived by differentiating the formula that indicates how much steering angle is required based on the curvature of the lane-based path to calculate the required changing rate of the steering angle according to the target changing rate of curvature.

However, this is only an example, and the first angle rate required to reach the target point may be calculated using other methods.

Next, the step of calculating the second angle rate corresponding to a limit value based on the path reliability $144 may be performed. Here, the value of the second angle rate to be limited according to the path reliability may be set experimentally, and the value may be adjusted according to the path reliability.

Next, the step of calculating the required steering angle rate by subtracting the second angle rate from the first angle rate S146 may be performed. By subtracting the second angle rate, which corresponds to the limit value based on the path reliability, from the first angle rate to determine the required steering angle rate, it is possible to control the vehicle by partially limiting the angle rate, which may fluctuate significantly when the lane information reliability decreases, and thus, it is possible to prevent the vehicle's behavior from changing abruptly and reduce the risk of accidents even when the lane recognition information is unstable.

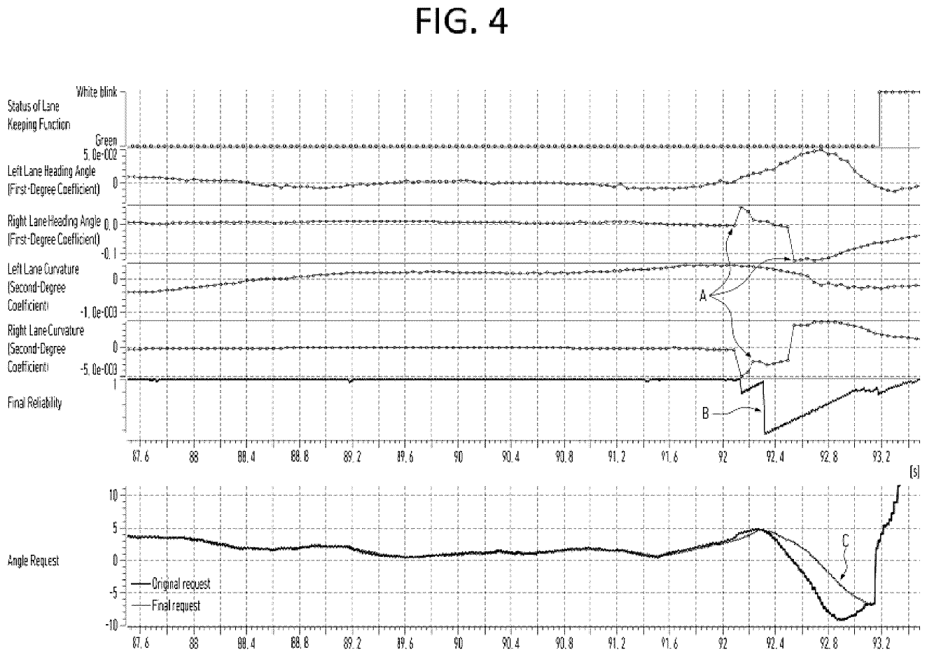

FIG. 4 is a graph illustrating the path reliability and the angle request of the vehicle in the case where the lane is incorrectly recognized in the method for controlling the vehicle in case of reduction in reliability of lane information according to the embodiment of the present disclosure.

Referring to FIG. 4, when the right lane line is misrecognized due to reasons such as the right lane line being damaged or the presence of an obstacle on the right lane line, the heading angle and the curvature with respect to the right lane line may change abruptly (see part A of FIG. 4).

In such cases, the changing rate of each coefficient of the n^{th} degree polynomial as the lane-based path increases, which results in a decrease in reliability of each coefficient. As a result, the path reliability of the lane-based path may decrease (see part B of FIG. 4).

On the other hand, according to an embodiment of the present disclosure, after calculating the first angle rate to reach the target point on the lane-based path and the second angle rate to be limited according to the path reliability, the required steering angle rate may be calculated by subtracting the second angle rate from the first angle rate.

In this way, the final required steering angle rate may be adjusted to be smaller compared to the required steering angle rate according to the conventional control (so that the slope of the graph of the steering angle over time becomes gentler) (see part C of FIG. 4).

That is, according to the method for controlling the vehicle in case of reduction in reliability of lane information in one embodiment of the present disclosure, by limiting the required angle rate which is based on detected lane lines when the lane information reliability decreases, and by driving the vehicle accordingly, it is possible to reduce the risk of accidents in cases where the lane recognition information is unstable and promote stable vehicle driving.

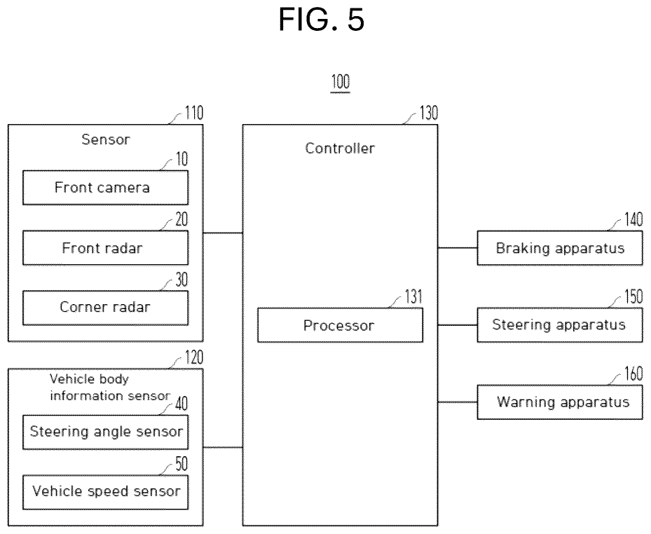

FIG. 5 is a control configuration diagram schematically showing the configuration of a system for controlling the vehicle in case of reduction in reliability of lane information according to embodiments of the present disclosure.

Referring to FIG. 5, the system for controlling the vehicle in case of reduction in reliability of lane information 100 according to embodiments of the present disclosure may comprise a sensor 110 configured to detect at least one lane line located ahead in the driving lane of the ego vehicle, and a controller 130 comprising at least one processor 131 configured to perform control of the ego vehicle based on detection information from the sensor 110.

The controller 130 may determine at least one lane-based path represented by the n^{th} degree polynomial based on the detected lane line, calculate the amount of change in each coefficient of the n^{th} degree polynomial, calculate the path reliability of the lane-based path using the amount of change in each coefficient, determine the required steering angle rate of the ego vehicle based on the path reliability, and control the ego vehicle according to the required steering angle rate.

Additionally, the system for controlling the vehicle in case of reduction in reliability of lane information 100 according to embodiments of the present disclosure may further comprise a vehicle body information sensor 120 configured to detect the vehicle body information of the ego vehicle.

The sensor 110 may comprise a front camera 10 mounted at the vehicle, which may detect the lane lines located in front of the vehicle. Additionally, the sensor 110 may further comprise a front radar 20 and/or at least one corner radar 30. However, the types of sensors included in the sensor 110 are not limited to these, and other types of sensors, such as ultrasonic sensors or LiDAR sensors, may also be included.

At least one sensor mounted at the ego vehicle may recognize the lane lines of the driving lane, enabling the lane following assist system of the driver assistance system to be performed.

Additionally, the vehicle body information sensor 120 may comprise at least one sensor for detecting the vehicle body information of the ego vehicle and may include a steering angle sensor 40 and a vehicle speed sensor 50. The steering angle sensor 40 of the vehicle body information sensor 120 may detect the steering angle of the ego vehicle, and the vehicle speed sensor 50 may detect the speed (lateral and longitudinal speeds) of the ego vehicle. Furthermore, the vehicle body information sensor 120 may comprise other sensors, such as a vehicle acceleration sensor, to detect the vehicle body information of the ego vehicle.

Furthermore, in the system for controlling the vehicle in case of reduction in reliability of lane information 100 according to the present embodiment, the controller 130 may be connected with a braking apparatus 140 configured to control the longitudinal driving of the vehicle and a steering apparatus 150 configured to control the lateral driving of the vehicle.

In addition, the controller 130 may control the steering apparatus 150 so that the lateral driving of the ego vehicle is controlled according to the determined required steering angle rate.

Additionally, in the system for controlling the vehicle in case of reduction in reliability of lane information 100 according to embodiments of the present disclosure, the controller 130 may be connected with a warning apparatus 160 configured to alert the driver of the ego vehicle.

Specifically, when the controller 130 determines that the path reliability of the lane-based path has decreased, the controller 130 may control the warning apparatus 160 of the vehicle to alert the driver. In this way, the driver can be notified in advance about the adjustment of the steering angle rate by the system.

The warning apparatus 160 may comprise at least one of a visual warning device or an auditory warning device.

Meanwhile, since the method for controlling the vehicle in case of reduction in reliability of lane information according to embodiments of the present disclosure performed by the controller 130 has been described in detail previously, detailed description will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiment of the present disclosure as described above, even when the lane lines are damaged or incorrectly recognized, the lane following assist system can be stably performed, and thus it is possible to provide the method and system for controlling the vehicle in case of reduction in reliability of lane information for improving the performance of the driver assistance system and promoting the driver's psychological stability.

Additionally, according to the method and system for controlling the vehicle in case of reduction in reliability of lane information, by calculating the path reliability of the lane-based path and adjusting the steering angle rate of the ego vehicle based on the path reliability, even if the lanes are damaged or incorrectly recognized, it is possible to decrease the impact of vehicle miscontrol and reduce the risk of accidents.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

10: Front camera
20: Front radar
30: Corner radar
40: Steering angle sensor
50: Vehicle speed sensor
100: System for controlling vehicle in case of reduction in reliability of lane information
110: Sensor
120: Vehicle body information sensor
130: Controller
131: Processor
140: Braking apparatus
150: Steering apparatus
160: Warning apparatus

1. A method for controlling a vehicle in case of reduction in reliability of lane information, comprising:
detecting at least one lane line located ahead in a driving lane of an ego vehicle using a sensor of the ego vehicle;
determining a lane-based path represented by an n^{th} degree polynomial based on the detected lane line;
calculating an amount of change in each coefficient of the n^{th} degree polynomial;
calculating a path reliability of the lane-based path using the amount of change in each coefficient;
determining a required steering angle rate of the ego vehicle based on the path reliability; and
controlling the ego vehicle according to the required steering angle rate.

2. The method of claim 1, wherein the calculating of the path reliability comprises:
calculating a coefficient reliability using the amount of change in each coefficient; and
calculating the path reliability by adding up coefficient reliabilities for a plurality of coefficients.

3. The method of claim 2, wherein the calculating of the coefficient reliability comprises: if the amount of change in each coefficient is smaller than a predetermined threshold value, setting the corresponding coefficient reliability to 1; and if the amount of change in each coefficient is greater than or equal to the threshold value, setting the corresponding coefficient reliability to a value smaller than 1.

4. The method of claim 3, wherein the calculating of the amount of change in each coefficient comprises calculating the amount of change in each coefficient during a minimum time interval for system operation.

5. The method of claim 1, wherein the determining of the required steering angle rate comprises:
calculating a first angle rate required to reach a target point based on the lane-based path;
calculating a second angle rate corresponding to a limit value based on the path reliability; and
calculating the required steering angle rate by subtracting the second angle rate from the first angle rate.

6. The method of claim 1, wherein the determining of the lane-based path comprises representing coordinates of both lane lines on the driving lane of the ego vehicle as separate n^{th} degree polynomials.

7. The method of claim 6, wherein the calculating of the path reliability comprises: determining a path reliability for a left lane line of the driving lane using amount of change in each coefficient of the n^{th} degree polynomial for coordinates of the left lane line; determining a path reliability for a right lane line of the driving lane using the amount of change in each coefficient of the n^{th} degree polynomial for coordinates of the right lane line; and determining an average value of the path reliability of the left lane line and the path reliability of the right lane line as the path reliability of the lane-based path.

8. The method of claim 1, wherein the determining of the lane-based path comprises representing lane center coordinates of the driving lane of the ego vehicle as the n^{th} degree polynomial.

9. The method of claim 1, wherein a first-degree coefficient of the n^{th} degree polynomial is a heading angle of the ego vehicle with respect to the lane-based path.

10. The method of claim 9, wherein a second-degree coefficient of the n^{th} degree polynomial is a curvature of the lane-based path.

11. A system for controlling a vehicle in case of reduction in reliability of lane information, comprising:
a sensor configured to detect at least one lane line located ahead in a driving lane of an ego vehicle; and
a controller comprising at least one processor configured to perform control of the ego vehicle based on detection information from the sensor,
wherein the controller is configured to determine a lane-based path represented by an n^{th} degree polynomial based on the detected lane line, calculate an amount of change in each coefficient of the n^{th} degree polynomial, calculate a path reliability of the lane-based path using the amount of change in each coefficient, determine a required steering angle rate of the ego vehicle based on the path reliability, and control the ego vehicle according to the required steering angle rate.

12. The system of claim 11, further comprising:
a driving apparatus configured to control a longitudinal driving of the ego vehicle; and
a steering apparatus configured to control a lateral driving of the ego vehicle,
wherein, the controller is configured to control the steering apparatus so that the lateral driving of the ego vehicle is controlled according to the required steering angle rate.

13. The system of claim 11, wherein the sensor comprises a front camera.

14. The system of claim 11, wherein the controller is configured to calculate a plurality of coefficient reliabilities using the amount of change in each coefficient and calculate the path reliability by adding up the plurality of coefficient reliabilities.

15. The system of claim 14, wherein if the amount of change in each coefficient is smaller than a predetermined threshold value, the corresponding coefficient reliability is set to 1 and, if the amount of change in each coefficient is greater than or equal to the threshold value, the corresponding coefficient reliability is set to a value smaller than 1.

16. The system of claim 15, wherein the controller is configured to calculate the amount of change in each coefficient during a minimum time interval for system operation.

17. The system of claim 11, wherein the controller is configured to calculate a first angle rate to reach a target point based on the lane-based path, calculate a second angle rate corresponding to a limit value based on the path reliability, and calculate the required steering angle rate by subtracting the second angle rate from the first angle rate.

18. The system of claim 11, wherein a first-degree coefficient of the n^{th} degree polynomial is a heading angle of the ego vehicle with respect to the lane-based path.

19. The system of claim 18, wherein a second-degree coefficient of the n^{th} degree polynomial is a curvature of the lane-based path.

20. A non-transitory computer-readable recording medium that records a program for executing a method for controlling a vehicle in case of reduction in reliability of lane information on a computer, the method comprising:
detecting at least one lane line located ahead in a driving lane of an ego vehicle using a sensor of the ego vehicle;
determining a lane-based path represented by an n^{th} degree polynomial based on the detected lane line;
calculating an amount of change in each coefficient of the n^{th} degree polynomial;
calculating a path reliability of the lane-based path using the amount of change in each coefficient;
determining a required steering angle rate of the ego vehicle based on the path reliability; and
controlling the ego vehicle according to the required steering angle rate.
